(19) United States
(12) Patent Application Publication
(10) Pub. No.: US 2011/0041406 A1
(43) Pub. Date: Feb. 24, 2011

(54) CLOSURE DEVICE FOR MAN-DOORS IN OVERHEAD GARAGE DOORS

(76) Inventors: Pedro Jimenez Del Amo, Munera (Albacete) (ES); Jesús Luis Carlos Blázquez, Munera (Albacete) (ES)

Correspondence Address: WENDEROTH, LIND & PONACK, L.L.P., 1030 15th Street, N.W.,, Suite 400 East, Washington, DC, 20005-1503, US

(21) Appl. No.: 12/528,850

(22) PCT Filed: Feb. 26, 2008
(86) PCT No.: PCT/ES2008/000105

§ 371 Date: Aug. 17, 2010

(30) Foreign Application Priority Data
Feb. 28, 2007 (ES) P200700523
Aug. 9, 2007 (ES) P200702248
Aug. 9, 2007 (ES) P200702249

(51) Int. Cl. E06B 3/50; E05F 7/00

(52) U.S. Cl. 49/13; 49/142

(57) ABSTRACT

The invention relates to a closure device for man-door in overhead garage doors. The invention is suitable for garage doors (12) having a man-door (33) which opens into the garage. The invention includes a first supporting element (1, 1a, 45) in the garage door (12) for retaining a moving element (4, 4a, 4b) assisted by at least one spring (30, 37, 41), such that the moving element projects from the garage door (12) to the exterior of the garage. The moving element is connected to a pin (25, 25a) provided in a second supporting element (28, 45) secured to the garage door (12) opposite the man-door (33). In order to close the door (12), the moving element presses against a fixed zone (13) of the garage and maintains the pin (25, 25a) in a position in which the man-door (33) is open and, when the garage door (12) is opened, the pin (25, 25a) closes the man-door, thereby ensuring that the man-door closes when the garage door (12) opens.

### OBJECT OF THE INVENTION

The invention, as stated in the heading of this specification, relates to a closure device for man-doors in overhead garage doors, the object of which is to prevent the aforesaid man-doors from accidentally open when the garage door is being opened.

Another object of the invention is to provide an indicator signaling to the users who are walking along the street as to the garage door being opened or closed so as to warn them of an existing danger, preventing possible injuries to those using the public thoroughfare.

### BACKDROUND OF THE INVENTION

Known in the state of the art is the use of overhead garage doors at garage entrances which also include man-doors incorporating a device for performing the opening and closing thereof, such that when the garage door is being opened, the man-door is located in the garage ceiling, as a result of which, if the man-door is not closed properly, it opens violently downward, with the risk involved therein, given that it can cause serious injuries to the user and, in the best of cases, material damage.

To prevent this problem, provision is made for the man-doors to open toward the outside of the garage door, which prevents the man-doors from opening when the garage door is being opened, but this creates some further problems, such as the man-door taking up space on the public thoroughfare when it is being opened, which can also cause injuries to those using the public thoroughfare. This configuration does not make it possible to keep the man-door open either, given that when it is open, it is an obstacle taking up space on the public thoroughfare and must therefore remain closed.

The document most similar to the invention which can be cited is the Spanish utility model of application number U 9700031, which describes a device for warning that vehicles are exiting a garage, which is a characteristic of which provision is also made in the present invention, but which, unlike the invention, includes an alarm generator which is activated by a sensor and does not comprise a safety device for closing a man-door which activates some optical and/or acoustic indicators on the garage door being opened, as is provided for in the invention.

In the state of art, no device assuring the closure of the man-doors which are included garage doors is known which include an opening mechanism toward the inside of the garage in order to prevent said man-door for opening when the garage door is being opened.

### DESCRIPTION OF THE INVENTION

The invention is applicable to man-doors of those included in garage doors. More specifically, it applies to those man-doors which open toward the inside of the garage such that when the garage door is being opened, the man-door is located in the roof, as a result of which if it is not properly closed, it could open violently downward, with the risk entailed therein.

To prevent this drawback, the invention has developed a new closure device for man-doors in overhead garage doors which is characterized in that it comprises a first supporting element attached to the garage door, on which a moving element assisted by at least one spring is retained, such that the moving element tends to project beyond the garage door toward the exterior of the garage due to the action of the spring. Additionally, the moving element is connected to a pin provided in a second supporting element attached to the garage door opposite the man-door, so that, on the garage door being closed, the moving element presses against a fixed zone of the garage on the exterior of the garage door, overcoming the action of the spring and thus maintains the pin in a position in which the man-door is open. This configuration also makes it possible, on the garage door being opened, for the moving element to cease pressing against the fixed zone of the garage on the exterior of the garage door, which determines that the spring will assist the moving element to cause the moving element and the pin to move, performing the closure of the man-door. The man-door is thus locked on opening the garage door and unlocked when the garage door is completely open, as a result of which there will be no risk of causing either material damages or personal injuries when the garage door is open.

The invention also comprises a linked switch of the first supporting element which, due to the action of the spring, is actuated by the moving element on opening the garage door to activate indicator means located on the exterior of the garage door to signal those using the public thoroughfare as to the garage door being opened. The indicator means may be acoustic, optical or both. This characteristics has the great advantage of warning those using the public thoroughfare of the fact that the garage door is being opened or closed so as not to cause any accidents.

In one embodiment of the invention, the moving element comprises a lever rotary on the first supporting element, which is linked to a able, which is, in turn, linked to a pin on which at least one spring is included, which, therefore, in this case, indirectly assists the lever by way of the cable, such that the rotary level turns the pin by means of the cable on closing the garage door and, on opening the garage door, releases the pin, which, by the action of the spring, closes and locks the man-door.

The cable is provided inside a sheath, being potentially movable, the ends of the sheath being attached by means of abutments respectively to the first and second supporting elements; at least one of said abutments being adjustable in order to adjust the position of the end of the sheath and keep the cable tightened properly in order to pull on the pin as desired.

The rotary lever is adjustable in length and depth toward the interior of the garage so that it can be adapted to the garage doors and man-doors of different dimensions.

The invention provides for the pin being linked to the manually-operated knob of said pin in order to make it possible to manually operate the pin in the event that it be so required.

In another embodiment of the invention, the moving element comprises a rod which is equipped with a lengthwise groove from which a cross-shaft runs which is attached to the first supporting element and against which the spring assisting it presses against in order to allow the longitudinal movement of the rod on the cross-shaft along the length of the groove. Therefore, in this case, unlike the immediately preceding embodiment described hereinabove, the spring assists the moving element directly instead of indirectly as in the preceding case. The rod is also connected to the pin by means of a cable which is linked to the cross-shaft and the pin, which is also assisted by a second spring. In this case, the cable is also placed inside a sheath such that it can be moved along the full length thereof. In turn, one of the ends of the sheath is attached to the roadway, and the other end is attached to the second supporting element, such that when the garage door is closed, the rod is pressed against the fixed zone of the garage, on the exterior of the garage door, this being a position in which it is overcoming the action of the spring assisting it, such that the rod is moved toward the interior of the garage, and therefore the end of the sheath on the cable moves away from the cross-shaft, which causes the cable pulling on the pin to tighten, overcoming the action of the second spring assisting it, so as to keep the man-door open. To the contrary, when the garage door is being opened, the rod ceases pressing on the fixed zone of the garage exterior to the garage door, which determines that, by the action of the spring which assists it, the rod projects toward the exterior of the garage door, the sheath moving in the same direction, which causes the cable to slacken and, as a result thereof, the pin moved toward the interior of the man-door by the action of the second spring which assists it, performing its closing.

The rod is provided such that it runs transversally across the garage door, unlike in the preceding embodiment hereinabove, in which the lever comprising the moving element does not go across the garage door.

In this embodiment, a switch can be incorporated which is actuated on the rod moving when the door is opening, such that said switch will actuate some blinking pilots located at the corners of the lowest part of the garage door.

In another embodiment of the invention, the first and second supporting elements are comprised of a pivot on which an oscillating arm is attached, at one of the ends of which the moving element is retained in an articulated manner, the pin being retained in an articulated manner at the other end such that this configuration makes it possible to perform the aforementioned functionality.

The moving element is also equipped with an arm which runs across one side of the garage door, and at the end thereof which presses against the fixed zone of the garage, to the exterior of the garage door, comprises a rolling element provided to roll over said fixed zone on which a surface slanted toward the side of the garage is included. Mention must also be made of the fact that the spring which assists the arms works on pressure when the garage door is closed, such that all of these characteristics make it possible, on opening the garage door, for the rolling element to move over the length of the fixed zone up to being positioned on the slanted surface, causing the pivoting of the oscillating arm, by the action of the spring, and thus the closing of the man-door, given that the ramp determines the arm also moving longitudinally in respect of the garage door, pulling on the oscillating arm, which, on pivoting on the supporting element, causes the pin which performs the closing of the man-door to move.

In this embodiment, the arm, which is the moving element, is also adjustable in length in order to make it possible for it to be adjustable to garage doors of different dimensions.

Additionally, in this embodiment, the arm crosses the side of the garage door by means of a bushing such that this bushing facilitates the longitudinal movement of the arm.

In this case, a switch which is actuated on the rod moving when the door opens can also be incorporated, such that said switch will actuate some indicators signaling that the garage door is being opened or closed.

In following, for the purpose of facilitating a better comprehension of this specification and comprising an integral part thereof, a number of figures are provided depicting the object of the invention for illustrative, non-limiting purposes.

### BRIEF DESCRIPTION OF THE FIGURES

FIG. 1. Shows a schematic view of one possible example of embodiment of the invention in which the garage door is in closed position.

FIG. 2. Shows a schematic overview of the location of the device of the invention from the immediately preceding figure hereinabove.

FIG. 3. Shows a schematic view of another possible example of embodiment in which the garage door is opening.

FIG. 4. Shows the immediately preceding figure hereinabove with the garage door closed.

FIG. 5. Shows a schematic view of a third example of embodiment of the invention in which the garage door is closed.

FIG. 6. Shows a view equivalent to the immediately preceding figure hereinabove in which the garage door is opening, which determines the closing of the man-door.

### DESCRIPTION OF THE PREFERRED EMBODIMENT

A description is provided in following of the invention based on the figures discussed hereinabove.

The invention consists of a closure device for man-doors in overhead garage doors (12), which is applicable in the case in which the man-door 33 opens into the garage, such that when the garage door (12) opened, the man-door 33 is located in the ceiling, as a result of which if it is not properly closed, it could fall violently downward, with the risk entailed therein.

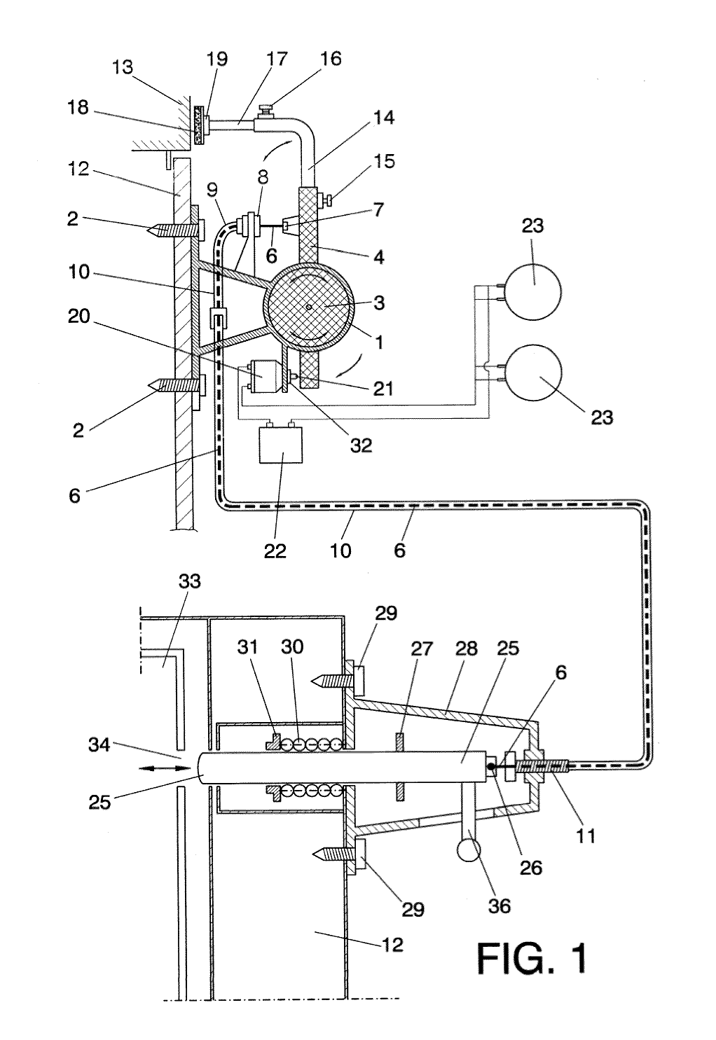

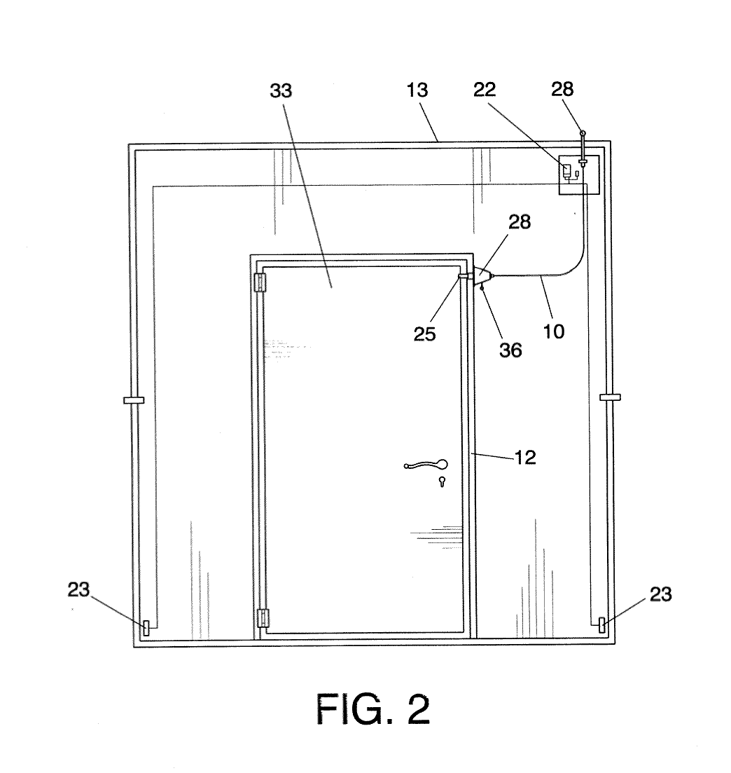

To prevent this drawback, in a first embodiment of the invention, as can be seen in FIGS. 1 and 2, the device comprises a first supporting element 1 which is secured by means of bolts 2 to the garage door 12, and on which a moving element is retained, which is comprised of a rotary lever 4 equipped with a shaft 3 which can be turned on the first supporting element 1. The rotary lever 4 is adjustable in length, for which purpose it has an elbowed section 14 which, by means of a set screw 15, makes it possible to telescopically adjust the length of the lever 4. The lever 4 is also adjustable in depth, for which purpose it comprises a telescopic section 17 provided in following to the elbowed section 14 and the position of which is fixed by means a set screw 16. The telescopic section 17 is finished off at its end by means of a rubber abutment 18 which is retained by means of a nut 19. This configuration makes it possible to adjust the lever 4, such that when the door 12 is closed, the abutment 18 is pressing against the fixed zone 13 of the garage, maintaining the rotary lever 4 in upright position. In this position, the lever is also pressing against the pushbutton 21 of a switch 20, which, by means of a battery 22 or by way of the electrical system proper, is connected to some flashing pilots located at the outer edges of the lowest part of the door 12, so that they can be readily seen by those using the public thoroughfare who are moving in the vicinity of the door 12. In this position, the pushbutton keeps the pilots turned off so that they does not call the attention of those using the public thoroughfare.

The lever 4 is linked to a steel cable 6, which is also connected to a pin 25 provided in a second supporting element 28, for which purpose the lever 4 comprises an extension 5 on which one head 7 of the cable 6 is retained, the other end of the cable 6 being retained in the pin 25 by means of a set screw 26. The cable 6 runs through a sheath 10 which, by means of an element 8, is secured to the first supporting element 1 by means of a curved abutment 9, and by means of an adjustable abutment 11, it is secured to the second supporting element. 28 for adjusting the tautness of the cable 6.

The second supporting element 28 is secured with bolts 29 to the garage door 12, opposite the man-door 33, such that the pin 25 is located in line with an orifice 34 of the man-door 33.

On the pin 25, there is a abutment 31 of a spring 30 which is located on the pin and which also presses against up to the second supporting element such that it pulls the pin 25 toward the orifice 34 and therefore indirectly assists the rotary lever 4 on which it pulls, maintaining the abutment 18 in contact with the fixed zone 13 of the garage when the garage door is closed. In this position, the cable pulls on the pin 25, overcoming the action of the spring, as a result of which it keeps it away from the orifice 34, and therefore the man-door 33 is unlocked and can be opened.

On opening the garage door 12, the abutment 18 moves away from the fixed zone 13 of the garage, and the spring 30 pulls on the lever 4 by means of the cable 6, as a result of which the pin 25 lodges in the orifice 34, performing the closing of the man-door 33. In this situation, the lever 4 ceases pressing on the pushbutton 21, as a result of which the pilots 23 are turned on, these pilots being visible to those using the public thoroughfare, warning them that the door is opening, is open or is closing, given that the pilots do not turn off until the door has once again been closed. The switch 20 has a depth adjustment 32 for positioning the pushbutton in the proper position allowing the functionality described to be performed.

The pin 25 is provided with a depth abutment 27 which limits how far it can be inserted inside the orifice 34, and the manual know 35, which makes it possible to manually open the man-door 33.

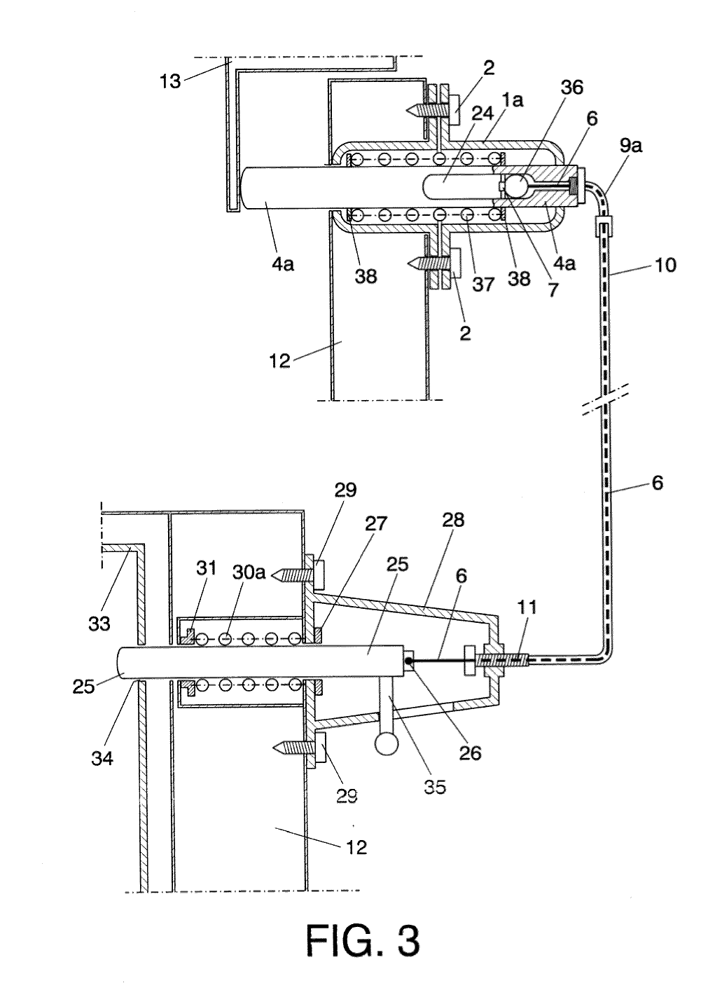

Another embodiment of the invention is described by way of FIGS. 2 and 3, in which the first supporting element 1a is secured to the door 12, just as in the immediately preceding embodiment described hereinabove, by means of bolts 2.

In this case, the moving element is comprised of a rod 4a which crosses the first supporting element 1a and which includes a longitudinal groove 24 in which a cross-shaft 36 is inserted, which is secured to the first supporting element 1a, such that the rod 4a can move lengthwise along the cross-shaft 36. The rad 4a is assisted by a spring 37 which presses against the cross-shaft 36 and the first supporting element 1a. These abutments can be defined, in the event that it may be so required, by washers 38 which will provide a better seating of the spring 37.

The second supporting element 28 and the elements it contains are identical to those previously described for the immediately preceding example hereinabove. In this case, one of the ends of the sheath 10 is secured by means of a curved abutment 9a to the rod 4a, and the head 7 of the end of the cable 6 is secured to the cross-shaft 36.

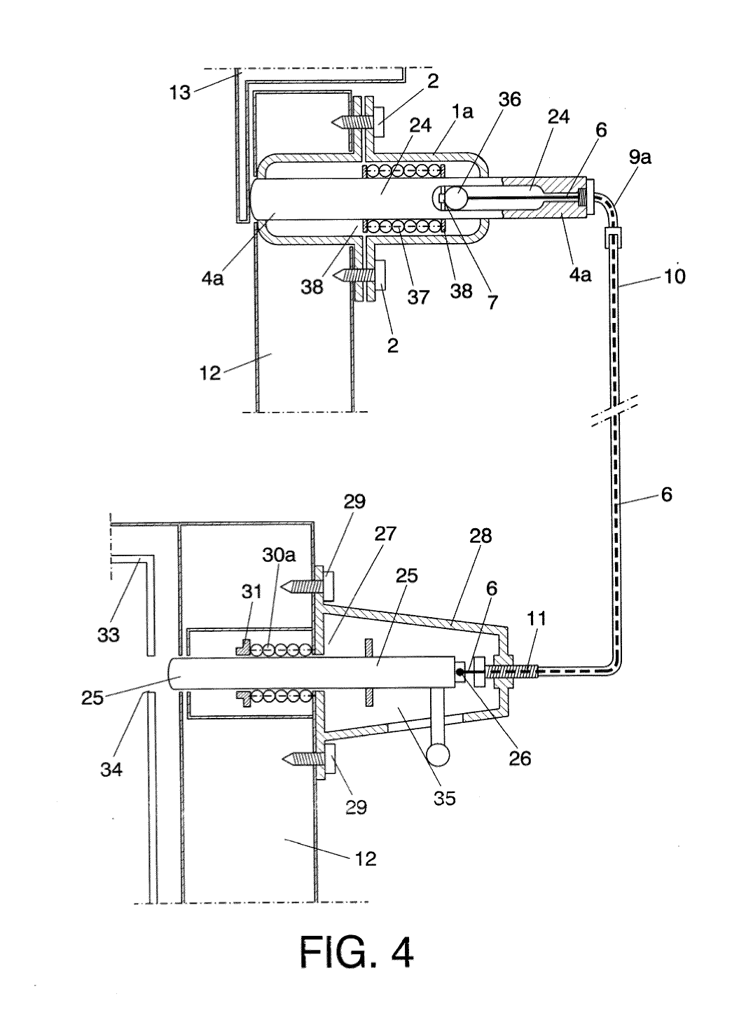

According to the description provided, it is readily understandable that when the garage door 12 is closed, as is shown in FIG. 4, the rod 4a presses against the fixed zone 13 of the garage, such that it is moved toward in the interior of the garage, overcoming the action of the spring 37. This position makes the curved abutment 9a of the sheath 10 be moved away from the cross-shaft 36, as a result of which the cable 6 is pulling on the pin 25, overcoming the action of the spring 30a, as a result of which said pin 25 is in its position retracted from the orifice 34 of the man-door 33.

When the garage door 12 is being opened, the spring 37, which assists the rod 4a, thrusts it toward the exterior of the garage until it ceases pressing against the fixed zone 13, which makes the curved abutment 9a approach the cross-shaft, causing the cable 6 to slacken, and by the action of the spring 30a, the pin 25 is inserted into the orifice 34 of the man-door 33, locking it into place such that it is prevented from being opened when the garage door 12 is being opened.

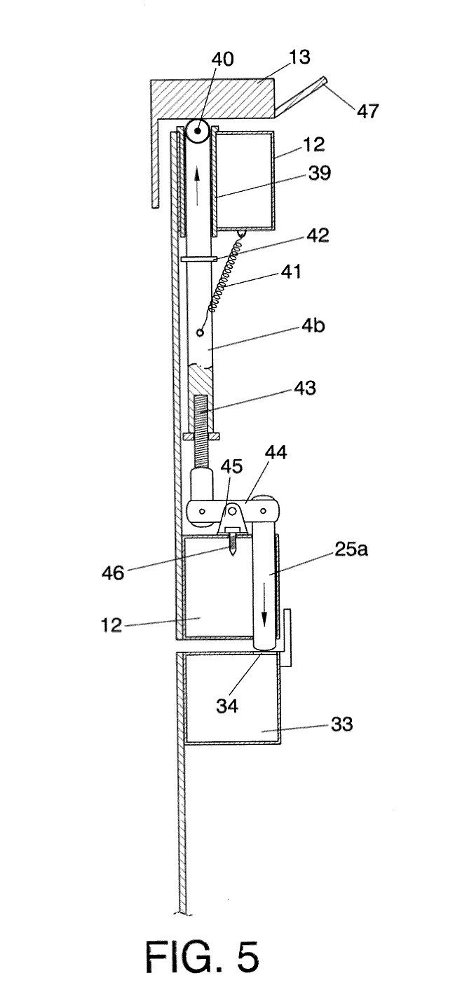

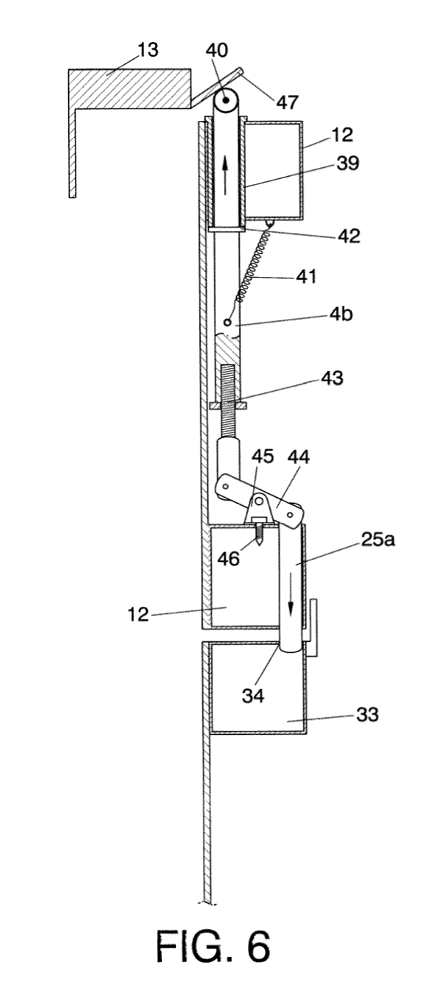

In another embodiment of the invention, according to FIGS. 5 and 6, provision is made for the invention to comprise a moving element comprised of an arm 4b which crosses one side of the garage door 12 through a bushing 38, through which it can move, the end of the arm 4b being equipped with a rolling element 40, such as, for example, a wheel or roller, which, when the garage door 12 is closed, is pressing against the fixed zone 13 of the garage, by the action of a spring 41 which assists the arm 4^{a} and which works on traction.

The arm 4a is equipped with a abutment 42 which limits the longitudinal movement which will be described at a further point herein.

The arm 4a is adjustable in length by means of a threaded grimmet 43 to allow for its proper adjustment.

Apart from the above, the device of the invention also comprises a pin 25a which is connected in an articulated manner to the arm 4a by means of an oscillating arm 44, which is supported on a pivot 45 which is secured by means of a bolt 46 to the garage door 12, such that said pivot 45 comprises the first support of the arm 4a and, at the same time, the second support of the pin 25a.

When the garage door is closed, on the arm 4a pressing against the fixed point 13, the fixed point maintains the pivot 25^{a} in a position in which it is out of the orifice 34 of the man-door 33, as a result of which the man-door is open.

When the garage door 12 is being opened, the arm 4a is set into motion by turning the wheel 40 on the fixed surface 13 until it comes to a slanted surface 47 toward the interior of the garage, such that, by the action of the spring 41, the arm 4a also moves lengthwise upward over the slanted surface 47, which makes the arm 4a pull up on the oscillating arm 44, the other end of which lowers and presses on the pin 25a, such that this pin is inserted into the orifice 34 of the man-door 33, performing the closing thereof and thus prevent it from accidentally opening when the man-door is located on the ceiling on the garage door 12 being opened.

1. CLOSURE DEVICE FOR MAN-DOORS IN OVERHEAD GARAGE DOORS, characterized in that it comprises a first supporting element (1, 1a, 45) secured to the garage door (12); said first supporting element retaining a moving element (4, 4a, 4b) assisted by at least one spring (30, 37, 41), such that the moving element projects from the garage door (12) to the exterior of the garage; and said moving element being connected to a pin (25, 25a) provided in a second supporting element (28, 45) which is secured to the garage door (12) in a position opposite to the man-door (33), so that, on closing the garage door (12), the moving element presses against a fixed zone (13) of the garage exterior to the garage door (12), maintaining the pin (25, 25a) in a position in which the man-door (33) is open and, when the garage door (12) is opened, the pin (25, 25a) closes the man-door.

2. CLOSURE DEVICE FOR MAN-DOORS IN OVERHEAD GARAGE DOORS, according to claim 1, characterized in that it comprises a switch (2) linked to the first supporting element (1, 1a, 45) which is actuated by the moving element (4, 4a, 4b) on opening the garage door (12) to activate indicator means (23) of the garage door (12) being open; said indicator means (23) being located in the outer part of the garage door (12) to signal to those using the public thoroughfare as to the garage door opening, and the indicators means (23) selected from the group consisting of acoustic, optical and a combination thereof

3. CLOSURE DEVICE FOR MAN-DOORS IN OVERHEAD GARAGE DOORS, according to claim 1, characterized in that the moving element comprises a rotary lever (4) on the first supporting element (1), which is linked to a cable (6), which is, in turn, linked to the pin (25) on which at least one spring (30) is included which indirectly assists the lever (4) via the cable (6), so that the rotary lever (4) pulls the pin (25) via the cable (6) on closing the garage door (12), and on opening the garage door (12), it releases the pin (25), which, by the action of at least one spring (30) closes the man-door.

4. CLOSURE DEVICE FOR MAN-DOORS IN OVERHEAD GARAGE DOORS, according to claim 3, characterized in that the cable (6) is provided through the inside of a sheath (10), with the possibility of moving, the ends of the sheath (10) being secured by means of abutments (9, 11) on the first and second supporting elements (1, 28), at least one of said abutments (11) being adjustable as regards the position of the end of the sheath (10).

5. CLOSURE DEVICE FOR MAN-DOORS IN OVERHEAD GARAGE DOORS, according to claim 1, characterized in that the rotary lever (4) is adjustable in length and depth toward the exterior of the garage.

6. CLOSURE DEVICE FOR MAN-DOORS IN OVERHEAD GARAGE DOORS, according to claim 1, characterized in that the pin (25) is linked to a manually-operated knob (36) of said pin.

7. CLOSURE DEVICE FOR MAN-DOORS IN OVERHEAD GARAGE DOORS, according to claim 1, characterized in that the moving element comprises a rod (4b) having a longitudinal groove (24) through which a cross-shaft (36) runs, which is secured to the first supporting element (1a), and to which the at least one assisting spring (37) presses against, the other end of which presses against the first supporting element (1a), in order to permit the longitudinal movement of the rod (4a) on the cross-shaft (36) along the the groove (24); and including a cable (6) which is linked to the cross-shaft (36) and the pin (25), and which is also included, with the possibility of moving, on the interior of a sheath (10), the ends of the sheath being secured to the rod (4a) and to the second supporting element (28); and the pin (25) being assisted by a second spring (30a), so that on finding the garage door closed, the rod (4a) moves the end of the sheath (10) away from the cross-shaft (36) by pulling on the cable (6) of the pin (25); and on opening the garage door (12), the sheath approaches the cross-shaft (36), slackening the cable (6), the pin (25) causing the man-door (33) to close by the action of the second spring (30a) which assists it.

8. CLOSURE DEVICE FOR MAN-DOORS IN OVERHEAD GARAGE DOORS, according to claim 7, characterized in that the rod (4a) crosses the garage door (12).

9. CLOSURE DEVICE FOR MAN-DOORS IN OVERHEAD GARAGE DOORS, according to claim 1, characterized in that the first and second supporting elements are comprised of a pivot (45) on which an oscillating arm (44) is connected, at one of the ends of which the moving element (14b) is rotary connected, and at the other end of which the pin (25a) is rotary connected.

10. CLOSURE DEVICE FOR MAN-DOORS IN OVERHEAD GARAGE DOORS, according to claim 9, characterized in that the moving element comprises an arm (4b) which crosses one side of the garage door (12), which at one of the ends thereof presses against the fixed zone (13), including a rolling element (40), and on which the spring (41) which assists it works on traction when the garage door is closed; the fixed zone (13) having a slanted surface (47) toward one side of the garage, so that, on the garage door opening, the rolling element (40) is located on the slanted surface (47), causing the pivoting of the oscillating arm (44) and the closing of the man-door (33) by means of the moving of the pin (25a).

11. CLOSURE DEVICE FOR MAN-DOORS IN OVERHEAD GARAGE DOORS, according to claim 9, characterized in that the arm (4b) is adjustable in length.

12. CLOSURE DEVICE FOR MAN-DOORS IN OVERHEAD GARAGE DOORS, according to claim 9, characterized in that the arm (4b) crosses the side of the garage door (12) by means of a bushing (39) which facilitates the longitudinal movement of the arm (4b).

13. CLOSURE DEVICE FOR MAN-DOORS IN OVERHEAD GARAGE DOORS, according to claim 2, characterized in that the moving element comprises a rotary lever (4) on the first supporting element (1), which is linked to a cable (6), which is, in turn, linked to the pin (25) on which at least one spring (30) is included which indirectly assists the lever (4) via the cable (6), so that the rotary lever (4) pulls the pin (25) via the cable (6) on closing the garage door (12), and on opening the garage door (12), it releases the pin (25), which, by the action of at least one spring (30) closes the man-door.
